(19) United States
(12) Patent Application Publication
(10) Pub. No.: US 2011/0259378 A1
(43) Pub. Date: Oct. 27, 2011

(54) ACOUSTIC CLEANING OF OPTICAL PROBE WINDOW

(75) Inventors: Jarle Skeidsvoll, Lonevag (NO); Bjørn Atle Øverland, Nesttun (NO); Stian Magnussen, Bergen (NO); Hallvard Tangen, Bergen (NO); Gunnar Alfheim, Bergen (NO)

(73) Assignee: PROANALYSIS AS, Bergen (NO)

(21) Appl. No.: 12/990,200

(22) PCT Filed: Apr. 30, 2009
(86) PCT No.: PCT/NO2009/000167

§ 371 Date: Jan. 25, 2011

(30) Foreign Application Priority Data
Apr. 30, 2008 (NO) 2008 2036

(51) Int. Cl. B08B 3/12

(52) U.S. Cl. 134/184

(57) ABSTRACT

The present invention relates to a system for removing deposits from measuring instruments measuring chosen characteristics of a fluid medium contained in a pipe or container, the measuring instrument comprising a window (10) and a first surface (12) having contact with said medium, said first surface (12) being positioned on one end defining a probe head (2) of an elongated member (13) adapted to be extending through the wall (6) of said pipe or container, the outer end of said member (13) being positioned outside said wall (6), the cleaning system comprising an acoustic transducer (5) positioned on the other end of said elongated member (13), wherein said acoustic transducer (5) is acoustically coupled to the elongated member (13) so as to couple acoustic energy thereto, the acoustic energy propagating along said member (13) to the end (2,12) of the probe (1) being in contact with the fluid inside the pipe or container, the resulting vibrations of which removing any contaminations from said window (10) by inducing cavitation.

This invention relates to a cleaning system for measuring instruments measuring chosen characteristics of a fluid medium contained in a pipe or container, especially for optical measuring probes for water, oil and/or gas flows. More specifically, the invention relates to a system for cleaning the window by in front of an optical measuring probe being positioned in a fluid medium by actively removing deposits.

In performing measurements in multiphase flows such as water, oil and/or gas flows, it is a well known problem that deposits form on the probe surface being in contact with the flow. This is especially relevant for optical probes, e.g. performing fluorescence measurements in the flow, as the probes comprise a transparent window toward the flow. If this window is covered by deposits it must be cleaned before measurements may continue. This cleaning may be performed by removing the probe from the flow, but this may be impractical and time consuming, in some cases requiring a local shut down of the system.

Several suggestions have been made to clean the window in situ and even during operation. One solution is discussed in EP 1480764 where an optical system is used emitting laser pulses being able to remove deposits. The problem related to the EP publication is that some soft deposits occurring in some fluid types are not removed by the laser pulses. Thus the probe has to be removed at appropriate intervals for cleaning.

Another solution is discussed by Dr. Jens Bublitz et al. in “Adaptation of approved laser-induced time-resolved fluorescence spectroscopy in offshore applications: Experience of 24 months measurements in produced water”, published on 7^{th} Oil-in-Water Monitoring Workshop, 23-24 Nov. 2005. In this publication tests are described where vibrations are used to remove deposits from a window in front of optical fibres used to perform fluorescence measurements. Two solutions have been tested. The first using a transducer coupled to the detection head so that both fibres and window are subject to vibrations. Thus has shown some practical problems such as the loss of the window and in practice Bublitz et al. have found a solution in which the window is glued into a recess in the head and an air jet is applied to the window to aid the deposit removal. The latter is impractical, as it, according to the publication, requires a second opening in the pipe and, additionally, may disturb or limit the flow. Another problem with said solution is that the optical fibres may be damaged by the vibrations.

A similar arrangement is shown in US application 2002/0167664 where the vibrations are provided by a piezoelectric ring element in the sensor head between the optical parts and the window. This complicates the probe head and makes it necessary to withdraw the probe in case of failure. Varying physical environments, e.g. varying temperature and pressure, may also represent a significant limitation to the design described in US application 2002/0167664.

An alternative solution according to the Bublitz et al. publication incorporates an acoustic transducer aiming its acoustic energy toward the probe head from another position in the pipe. This also requires two openings in the pipe wall, which may be impractical, either by requiring a special physical arrangement or limiting the freedom in positioning the probe as well as disturbing or limiting the fluid flow in the pipe.

Patent application WO 2008/015390 describes principles and embodiments of an optical interfacial element and an optical system integrated with a high power acoustic resonator where the high power acoustic resonator may be used for acoustically cleaning of the optical interfacial element by transmitting acoustic vibrations onto the optical interfacial element. In applications where high energy acoustic vibrations are required for cleaning the optical interfacial element, e.g. at high pressure, a full integration of the optical interfacial element with the acoustic resonator can result in physical erosion of the optical interfacial element, regardless of material.

It is an object of this invention to provide a simple solution for removing deposits from an optical measuring probe window without damaging the optical wave guides or other equipment therein and without requiring extra openings or surrounding systems complicating the installation and operation of the measuring probe.

This object is obtained using a system as stated above and characterised as mentioned in the accompanying independent claims.

The invention thus provides a system where acoustic waves propagate along the probe shaft to the probe head. Preferably, signals transmitted from the probe head to the instruments outside the fluid through a member being acoustically insulated from the acoustical vibrations, preferably coaxially positioned inside the member transmitting the acoustic vibrations.

The invention will be described below with reference to the accompanying drawings, illustrating the invention by way of examples.

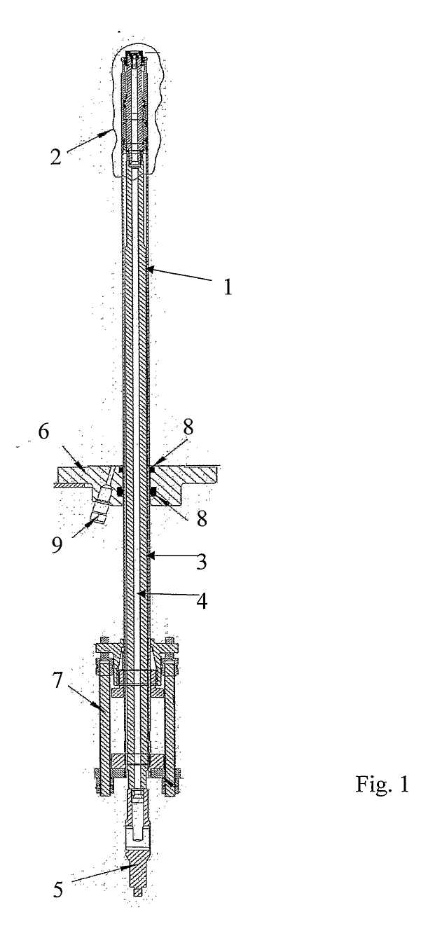

FIG. 1 illustrates a system according to the invention.

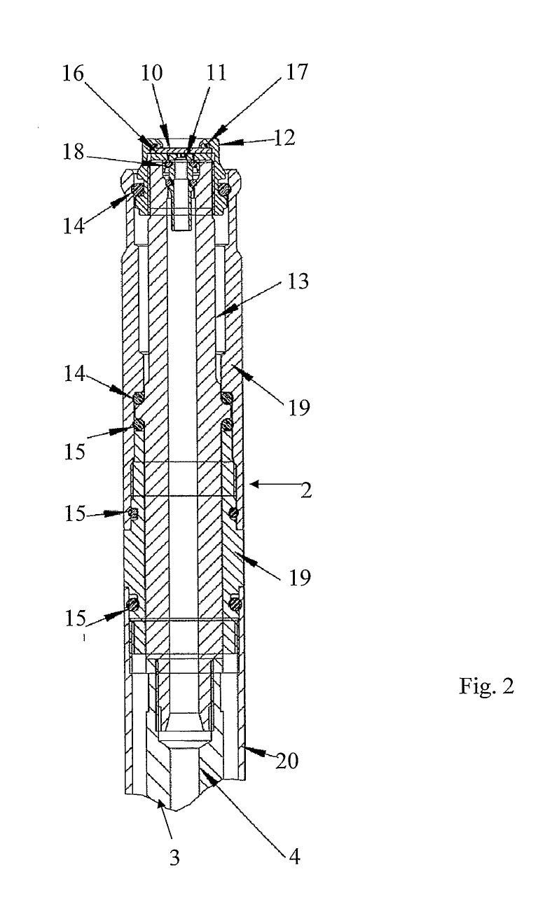

FIG. 2 illustrates one embodiment of the probe head section of the system illustrated in FIG. 1.

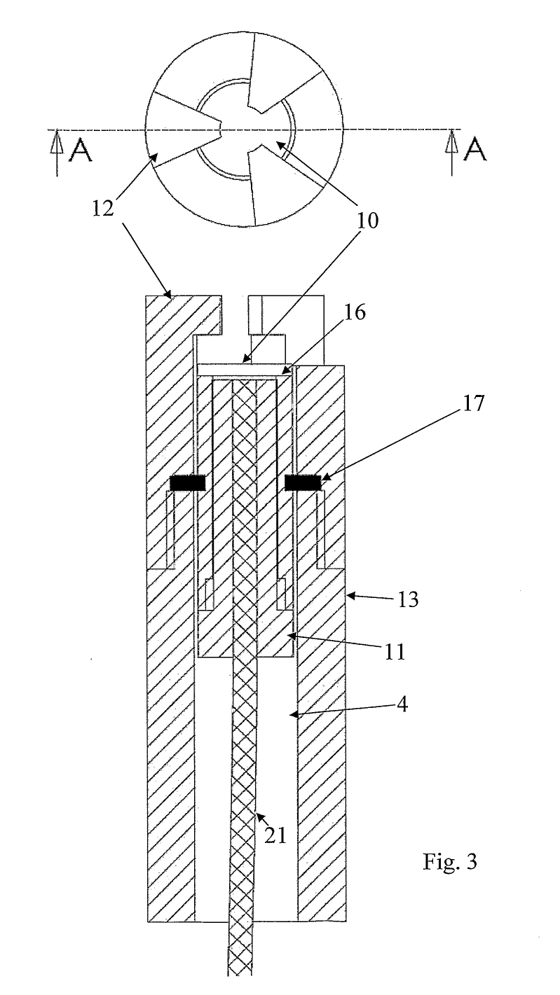

FIG. 3 illustrates a preferred embodiment of the probe head section of the system illustrated in FIG. 1.

As is illustrated in FIG. 1 the invention relates to a probe 1 penetrating a pipe wall or container 6. The probe has a probe head 2 providing e.g. optical measurements in a medium contained in the pipe or container 6, and in the opposite end having mounting means 7 and connection means for the relevant instruments and control means. The pipe or container 6 may be of any type containing fluids, like mixtures of water, oil, gas, etc. where there is need for performing measurements and especially if there is a risk of deposits on the probe head interfering with the measurements to be performed. In FIG. 1 an additional opening 9 is provided in the wall, e.g. for pressure release purposes.

According to the invention the probe 1 is provided with an acoustic transducer 5 in the opposite end from the probe head 2. The probe includes an elongated member 3, and the acoustic transducer 5 excites the member and the acoustic waves propagate along it toward the probe head 2. In order to protect the signal transmitters to or from the probe head the elongated member 3 is preferably formed as an annular pipe with an inner channel 4 through with the transmission lines may be drawn. In FIG. 1 the probe 1 is connected to the container wall 6 through O-rings 8 or similar, sealing the through-hole. The elongated member 3 inside the probe is acoustically insulated from the outer shell of the probe 1 and thus also from the pipe or container wall 6, while the transmission lines and transducers inside the inner channel 4 are preferably acoustically insulated from the elongated member.

FIG. 2 illustrates the probe head at the end of the elongated member 3,13. The elongated member 3 extends through the probe head 2 all the way to the end 13 and is acoustically coupled to the oscillating front of the probe 12.

In the intended use of the invention the front surface 10 is a transparent window transmitting optical measuring signals from and to an optical gauge 11 behind the window and inside the probe head 2. The gauge 11 may be constituted by optical fibre ends transmitting light to or from the flow, a digital camera with light sources to provide images of the flow, etc. In order to reduce the acoustic vibrations propagating from the probe head 2,12 to the gauge 11 the gauge 11 is acoustically isolated from the elongated member 3 by O-rings 17,18 so that the elongated member 3 vibrates so as to remove the deposits on the window while the gauge 11 and corresponding signal and power conductors coupled in the channel 4 to the gauge 11 is exposed to a reduced amount of vibration and thus protected being against damage.

The elongated member 3,13 may as indicated in FIGS. 1 and 2 be positioned inside an outer tube 19,20 which may provide a fluid seal and also acoustic insulation for the environment around the probe 1. In FIG. 2 the outer tube 19,20 is coupled to the elongated member by O-rings 14,15 or similar.

As the applied vibrations are preferably in the longitudinal mode the vibrations damping O-rings 14,15,17,18 and their mounts are preferably adapted to allow for vibration movements in the longitudinal direction of the probe while damping movements in the transversal direction. While exemplified as O-rings any device providing both vibration damping and seal may be used.

In FIG. 2 the window 10 is mounted at the end of the probe head 2 coupled to the gauge 11 but acoustically insulated from the elongated member 3. The outer edge 12 of the probe head is an extension of the elongated member 3,13 and may thus define a vibrating surface which so as to couple acoustic energy to the fluid in the vicinity of the probe window 10, the vibrations producing cavitation at the window 10 and thus remove deposits therefrom. Different types of sealing such as O-rings 17,18 may be used between the vibrating 12 and non-vibrating parts 10,11 to avoid intrusion of fluids into the probe.

In FIG. 3 a preferred embodiment of the invention is shown in which the window 10 and the outer end 12 of the elongated member 3,13 is shown. The outer end 12 extends outside the window and as is shown in FIG. 3 it may be shaped so as to allow fluid flowing close to the window 10 while also extending over the window so as to focus a part of the acoustic energy toward the window surface. In FIG. 3 this is obtained by claw shaped extensions outside the window. The window is thus fastened to the gauge with suitable coupling means 16 or adhesives. In addition the gauge 11 is coupled to the inside of the elongated member 13 through sealing rings such as O-rings 17 that may both avoid introduction of fluids into the probe and reduce the acoustic vibrations propagating from the elongated member 13 to the gauge 11. In order to obtain this there is an annular space between the gauge 11 and the elongated member so as to let them move relative to each other to a certain degree.

The window 10 is preferably made from sapphire, but other hard transparent materials may be contemplated. Due to transmission characteristics for the acoustic energy and mechanical requirements due to chemical, mechanical and thermal conditions the metallic parts transmitting the acoustic energy 3, 13 are preferably made from titanium or alloys thereof. The outer parts are made from standard materials for the environment in which the equipment is to be used, such as duplex steel and/or other stainless steel alloys.

The acoustic source 5 may be chosen from a number of available types depending on the intended use and the local process environment including fluid content. types of contaminations and pressure. Preferably the frequency range is in the range of 20-30 kHz and the amplitude is up to 50 μm in the longitudinal direction.

To summarise the invention thus relates to a system for removing deposits from measuring instruments or probes 1 measuring chosen characteristics of a fluid medium contained in a pipe or container 6. The measuring instrument comprising a first surface 10 having contact with said medium, the first surface being positioned on one end defining a probe head 2 of an elongated member 3 being adapted to be extending through the wall of said pipe or container. The outer end of the elongated member is positioned outside said wall and the cleaning system comprises an acoustical transducer 5 positioned on the outer end of said elongated member, wherein the acoustic transducer is acoustically coupled to the elongated member 3 so as to couple acoustic energy thereto, the acoustic energy propagating along said member to said first surface being in touch with the medium inside the pipe or container. The resulting vibrations applied on the end 12 of the probe head 2 being shaped so as to transmit part of the acoustic energy through the fluid to the window close by the probe head end thus by cavitations in the fluid removing any contaminations deposited on the window surface.

Preferably the measuring instrument comprised an inner element 21 positioned in a channel inside the elongated member 3 and being at least partially acoustically insulated from said elongated member so that the vibrations of the elongated member does not harm the inner element 21 or affect any signals propagating therein.

The inner element 11 may contains optical waveguides 21 extending from a position behind said first surface toward a measuring instrument outside said pipe or container, in which case the first surface is constituted by a window surface 10 being transparent to the optical signals transmitted though the waveguides. Alternatively, the inner element contains an optical sensing system, e.g. an imaging system, coupled through electronic or optical signal conductors so as to transmit signals from said imaging system to measuring instrument outside said pipe or container, the first surface being constituted by the outer surface of a window being transparent to the optical signals transmitted though the waveguides. Applications may also be contemplated where other measurements, like certain electric characteristics of the medium, is measured in which case the nature of the window will be chosen accordingly.

The acoustic energy used to clean the inner surface of the probe being in contact with the fluids in the pipe or container is preferably constituted by pressure waves propagating longitudinally along the elongated member thus providing vibrations to the inner surface of the probe head having an axial direction, the vibrations causing the extensions 12 on the probe head to vibrate and thus transmit the energy toward the window so that contaminations are removed.

1. A system for removing deposits from a measuring instrument measuring chosen characteristics of a fluid medium contained in a pipe or container, wherein the measuring instrument comprises a first surface having contact with said medium, said first surface being positioned on one end defining a probe head of an elongated member adapted to extending extend through the wall of said pipe or container, on another end of said elongated member opposite the end being positioned outside said wall, the cleaning system comprises an acoustical transducer positioned on the other end of said elongated member, wherein said acoustic transducer is acoustically coupled to the elongated member so as to couple acoustic energy thereto, the acoustic energy propagating in said member to said first surface, wherein the probe head is provided with a gauge located in operational contact behind the first surface through which the characteristics are measured, wherein the gauge is acoustically insulated from the first surface, wherein a signal transmitter transmitting measurement signals from the gauge out of the system for further processing are arranged coaxially inside the elongated member and are partially acoustically insulated from said elongated member.

2-8. (canceled)

9. The system according to claim 1, wherein the elongated member is an annular pipe comprising an inner channel, wherein the signal transmitter is arranged acoustically insulated from the walls of said channel.

10. The system according to claim 1, wherein the signal transmitter comprises optical fibres.

11. The system according to claim 1, wherein the elongated member is located inside an outer tube providing fluid sealing and acoustical insulation around the system.

12. The system according to claim 1, wherein acoustical insulation elements are adapted to transmit acoustical waves in a same direction as the elongated member while at the same time are damping acoustical waves in a transversal direction of said same direction as the elongated member.

13. The system according to claim 1, wherein an outer end of the elongated member is extended outside the first surface and is bent towards a centre of the first surface.

14. The system according to claim 13, wherein a member of the measuring instrument comprising the first surface is acoustically insulated from the elongated member.

15. The system according to claim 13, wherein a distance between the bended outer end of the elongated member and the first surface is chosen to provide removal of contaminations on the first surface when the acoustical transducer is providing vibrations of the bended outer end of the elongated member.

16. The system according to claim 13, wherein the outer end of the elongated member is shaped as at least one claw.

17. The system according to claim 1, wherein the first surface is a transparent surface of the measuring instrument.

18. The system according to claim 1, wherein the acoustic transducer comprises an acoustical source providing signals in a frequency range of 20-30 kHz.

19. The system according to claim 1, wherein the acoustic transducer comprises an acoustical source arranged to provide acoustical energy providing pressure waves in the body of the elongated member.

20. The system according to claim 19, wherein amplitudes of the pressure waves are in the range of 50 μm in the longitudinal direction of the elongated member.
